(19) United States
(12) Patent Application Publication
(10) Pub. No.: US 2017/0001137 A1
(43) Pub. Date: Jan. 5, 2017

(54) AIR FILTERING DEVICE WITH SALT LOAD DETERMINATION AND METHOD FOR MONITORING FILTRATION

(71) Applicant: CAMFlL AB, Stockholm (SE)

(72) Inventor: Erik Lans, Västerljung (SE)

(21) Appl. No.: 15/105,418

(22) PCT Filed: Dec. 19, 2013
(86) PCT No.: PCT/SE2013/051569

§ 371 Date: Jun. 16, 2016

(51) Int. Cl. B01D 46/00

(52) U.S. Cl. CPC B01D 46/0086; B01D 46/008

(57) ABSTRACT

An air filter device includes an air flow intake, an air outlet and at least one air filter including a filter medium capable of removing particulate material and/or airborne molecular contamination (AMC) from an air flow passing through the filter. The amount of salt entrapped by the filter medium is determined, and the filter device is arranged to be able to provide an output corresponding to the salt load value. A method of monitoring the filtration condition of a filter uses a filter monitoring system, which includes the air filter device and a control. The control includes a memory and a processor. The memory is arranged to store computer readable code that executes the method.

### TECHNICAL FIELD

The present invention relates to an air filter device for use in off-shore or coastal environments, a method of monitoring a filtration condition of a filter unit in an air filter device, a system including an air filter device, and a computer program product.

### BACKGROUND

Off-shore or coastal installations comprising machines, which need an air supply of for example cooling air, may be damaged due to salt which enters the machine through the air intake. This applies in particular to machines with movable parts, such as gas turbines or wind turbines, or machines including sensitive electronics. Airborne salt particles may deposit on machine parts and cause functional degradation and/or corrosion. In order to protect the machine, filters may be arranged in the air intake to prevent salt particles and other particles from reaching the sensitive parts of the machine. When a certain amount of salt particles have been entrapped by the filter, the ability of the filter to entrap further salt may decrease, and salt may then migrate through the filter and follow the air stream downstream the filter into the machine, where it could cause damage. It is therefore important to replace the filter before the maximum capacity has been reached. US2004/0055900A1 discloses a method and apparatus for monitoring salt saturation in a filter arranged in the air inlet of an apparatus comprising a combustion turbine. An air flow sampling sensor, which is arranged in the air stream between the filter and the apparatus comprising a combustion turbine, is used to detect the presence of salt particles in the air stream.

It would be desirable to be able to monitor the degree of salt saturation of the filter to avoid the risk of damage in the machine to which the filtered air stream is supplied, thereby enabling replacement of the filter before risk of damage of the machine parts. There is thus a need for an improved means of monitoring the filter condition with regard to salt saturation.

### SUMMARY OF THE INVENTION

By means of the present invention the filter condition can be monitored in a safer and more effective way.

The present invention relates to an air filter device comprising an air flow intake and an air outlet and at least one air filter unit including a filter medium capable of removing particulate material and/or airborne molecular contamination (AMC) from an air flow passing through the filter unit. The filter medium has an upstream surface directed towards the air flow intake, and a downstream surface directed towards the air flow outlet, and a salt load determining means for determining presence of salt entrapped by the filter medium is provided in connection to the filter medium. The filter device is arranged to be able to provide an output corresponding to the amount of salt entrapped by the filter medium by means of said salt load determining means.

The salt load determining means is preferably a sensor. The means for determining the amount of salt entrapped by the filter medium is preferably a sensor for example by determining a conductivity of the filter medium, and is positioned on the filter medium.

By arranging the salt load determining means or sensor directly on the surface of the filter medium, an approaching saturation of the filter can be detected before the salt actually has begun to migrate through the filter. Thereby, preventive actions can be taken to avoid salt particles reaching the downstream side of the filter.

The salt load determining means is preferably positioned on, or adjacent to, the upstream surface of the filter medium. The air filter device advantageously comprises least a first filter unit and a second filter unit, wherein the first filter unit includes the salt load determining means positioned on the filter medium, said first filter unit being arranged upstream of a second filter unit. One or more additional filter units may be arranged upstream said first filter unit, and the filter unit closest to the air intake preferably includes a filter medium with lower filter class than the filter units downstream thereof. At least one salt load determining means may be positioned on the surface of each of at least two different filter units. Preferably, the air filter device further comprises a display unit associated with the sensor for displaying a conductivity value of the filter medium.

The invention also relates to a method of monitoring the filtration condition of a filter unit in an air filter device as described above, which method comprises the steps of:
obtaining a salt load value of the filter medium from said air filter device, said salt load value corresponding to the amount of salt entrapped by the filter medium;
comparing the salt load value from said air filter device with a predetermined salt load limit value;
if said salt load value from said air filter device is equal to, or exceeds, said predetermined salt load limit value, generating a message indicating that preparations should be undertaken to replace the filter unit for a fresh one.

The salt load value is preferably a conductivity value, and the predetermined salt load limit value is preferably a conductivity limit value. The predetermined salt load value conductivity limit value preferably represents a filtration condition where a predetermined degree of the filtration quantity capacity has been reached.

The invention also relates to a filter monitoring system, comprising an air filter device as described above, and further comprising a control unit comprising a memory unit and a processor, wherein the memory unit is arranged to be able to store computer readable code that when executed on the processor performs the above method, and further preferably comprises means for communication with an external recipient. The invention also relates to a computer program product arranged to perform the above method, when executed in the filter monitoring system.

### BRIEF DESCRIPTION OF THE DRAWINGS

FIG. 1 is a schematic view of the air filter device of the invention according to a preferred embodiment;

FIG. 2 is a schematic view of an air filter device of the invention according to another preferred embodiment;

FIG. 3 is a schematic view of an air filter device of the invention according to another preferred embodiment;

FIG. 4 is a schematic view of an air filter device of the invention according to another preferred embodiment;

FIG. 5 is a flow diagram of a method of monitoring a filtration condition of a filter unit in an air filter device of the invention;

FIG. 6 is a flow diagram of a method of experimentally determining maximum salt saturation in a filter unit;

FIG. 7 is a schematic view of a system including an air filter device of the invention;

FIG. 8 shows the result of test in which the effect of salt load was evaluated;

FIG. 9 shows the result of test in which the effect of relative humidity was evaluated.

### DETAILED DESCRIPTION

The invention aims at preventing salt particles from entering a machine, in off-shore or coastal application, to which filtered air is supplied, since such particulate material can be detrimental to the parts of the machine. One phenomenon that can be utilised in the present invention is that saline solutions are conductive. Studies performed by the inventor have shown that the conductivity is linked to the amount of salt in the filter, and the conductivity will give an indication of the salt concentration on the filter surface. When salt is present on a filter surface, a conductivity can be detected as the salt will be at least partially in solution due to the humidity of the air in off-shore or coastal environment. Conductivity referred to in the context of the present invention relates to electrical conductivity. Salt particles entrapped by the filter medium can also be detected by means of spectroscopy.

The air filter device of the invention comprises an air flow intake and an air outlet, and at least one air filter unit including a filter medium capable of removing particulate material and/or airborne molecular contamination (AMC) from an air flow passing through the filter unit. Filter materials capable of removing airborne molecular contamination (AMC) are also capable of removing particulate material. It is to be noted that filter media capable of removing particulate material inevitably let through a small amount of particles. The amount that can pass the filter depends on the removal efficiency of the filter medium, and may be infinitesimal, but is never zero. Removal efficiency is normally expressed in percent of the total particle content in an air stream. For the sake of simplicity, the removal efficiency of a new unused filter medium is, in the following description, referred to as being 100%, i.e. not letting through any particulate material. Thus, when the expression “no particles” or the like is used, it means no particles in addition to what could be expected in comparison with a fresh unused filter medium. The present invention aims at a way of determining when the salt load of the filter medium has reached such a level, that the particle amount in the air stream downstream the filter step deviates from what could be expected downstream of a fresh unused filter.

Any salt present in the air may be in the form of particles or saline droplets. The air filter device of the invention is intended for use in applications where the ambient air has high relative humidity, 60-100%, which is typical for off-shore or coastal environments. The most reliable results are obtained in conditions where the relative air humidity is 80-100%. The filtered air from the last filtration step is intended to be supplied to a machine or the like comprising components such as for example a compressor or a turbine or electrical equipment, which are sensitive to salt and may be damaged thereby. Such machines are typically considerably more expensive than the filter units of an air filter device, or may be more difficult to replace, so it is advantageous from an economical perspective to replace the filter units for fresh ones before they are fully saturated, since this will minimise the risk of salt particles migrating through the filter medium. If the condition of the filter unit can be adequately monitored with regard to its expected remaining filtration quantity capacity, an early indication can be obtained that it is time to replace the filter. After replacement the filter unit can be discarded.

The filter medium of the at least one filter unit in the air filter device has an upstream surface directed towards the air flow intake, and a downstream surface directed towards the air flow outlet, by which is meant that the upstream surface is the side of the filter medium, which is first reached by the air flow, and the downstream surface is on the side where the air stream leaves the filter unit after having passed through the filter medium. In the case of a V-bank filter both the upstream and the downstream surface may be at an angle with respect to the flow direction. Each filter unit of the filter device represents a separate filtering step. A salt load determining means for determining the presence or the amount of salt entrapped by the filter medium is provided in connection to the filter medium. Preferably, the salt load determining means is a sensor. By sensor is meant a device comprising one or more sensing probe and an instrument capable of sensing a condition to be monitored. The output obtained from the filter device is an output value corresponding to this condition.

In the following the salt load determining means is referred to as a sensor for determining conductivity, although any other suitable means or sensor could be used for this purpose.

The sensor for determining conductivity is positioned on the filter medium, and the filter device is arranged to be able to provide an output corresponding to a conductivity value by means of said sensor, which means that the conductivity value obtained by the sensor can be retrieved for analysis and comparison with a limit value. The conductivity value obtained by means of the sensor can give information which is correlated to the degree of saturation of the filter, and gives an indication of whether it is time to change the filter unit for a fresh one.

The conductivity value determined by means of the sensor can be obtained as conductivity or resistivity. These two parameters are related to each other and a change therein can be detected in the filter medium if there is a salt deposit thereon provided that the relative humidity in the air stream is high enough to cause at least a part of the salt to be in solution. The sensor is intended to measure the conductivity of the filter medium in situ, during operation of the air filter device.

The sensor can be positioned anywhere on the filter medium, i.e. on the upstream surface or on the downstream surface, or be inserted into the filter medium to measure the condition inside the filter medium material. Positioning the sensor on the downstream side of the filter medium can give an indication that a saturation limit is already reached, which would indicate that the filter unit should be replaced immediately. Preferably, the sensor is positioned on, or adjacent to, the upstream surface of the filter medium, thereby giving an earlier detection of beginning saturation of the filter medium, since conductive material, i.e. dissolved salt, will first occur on the upstream surface of the filter unit.

The air filter device preferably comprises at least two filter units arranged in series in the air stream, so that they represent two filtering steps, where a first filter unit is arranged upstream a second filter unit, and the second filter unit is closer to the air outlet and to the machine to which the filtered air is to be supplied. The first filter unit includes the sensor positioned on the filter medium. By positioning the sensor in the air filter device so that at least one filter unit (the second filter unit) is arranged downstream the filter unit holding the sensor (the first filter unit), it can be ensured that no particles reach the machine, since saturation of the filter medium of the first filter unit will be detected long before there is a risk of saturation of the second downstream filter unit, which is closest to the air outlet, and any salt particle escaping the first filter unit will be entrapped by the second filter unit. When the conductivity limit value is detected by the sensor, there is still one filter unit left for the inlet air to pass before reaching the machine. Thereby, the removal of particles from the air stream is further improved, since the last filter unit can function as a safety filter unit ensuring that the number of salt particles reaching the machine is minimized.

As an alternative, it is also possible to locate the sensor on the filter unit closest to the air outlet (the second filter unit). Detection of the conductivity limit value, indicating the approaching saturation, would then require that action be taken on shorter notice, but on the other hand the filter units can be more fully utilized.

In addition to the above mentioned first and second filter unit, the air filter device may advantageously include one or more additional filter units, i.e. one or more filtering steps, in series in the air stream. Such additional filter units are preferably arranged upstream of the above mentioned first filter unit, so that a portion of particles or airborne molecular contaminations (AMC) present in the air stream can be removed before its entry into the filter unit holding the sensor, thereby decreasing the load on the subsequent filter units. The filter unit arranged closer to the air intake can preferably include a filter medium with lower filter class than filter units downstream thereof, which means that coarser materials such as e.g. insects or coarser sand particles can be entrapped by a particle filter unit closer to the air intake, while salt particles and AMC is removed from the air stream in a more downstream filter unit.

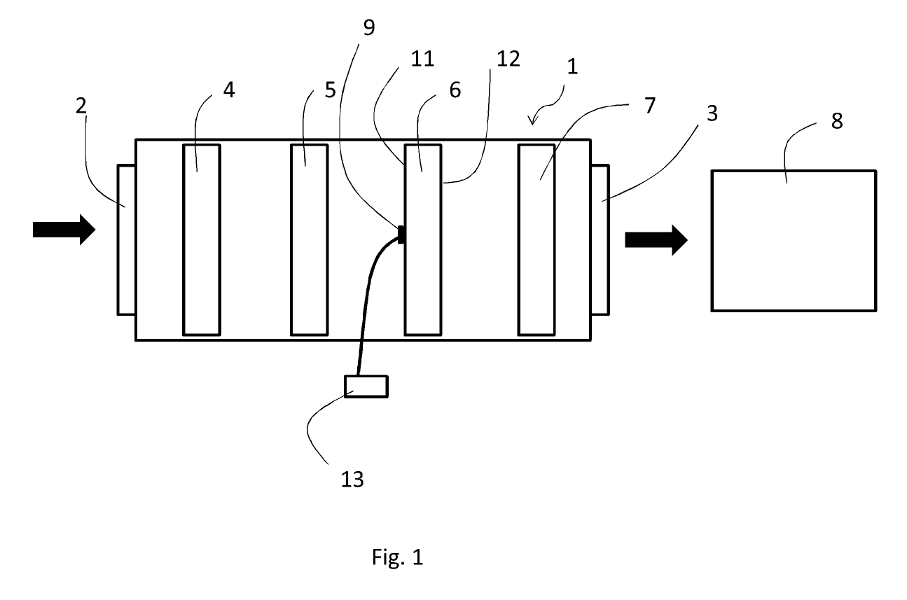

Examples of embodiments of the air filter device are shown in FIGS. 1-4 as described below. Elements which are present in more than one embodiment have the same reference throughout.

FIG. 1 shows an air filter device 1 comprising an air flow intake 2 and an air outlet 3, and four air filter units 4, 5, 6, 7. Ambient air having a high relative humidity and containing salt and any other particular material enters the air filter device through the air intake 2, and the air stream is led through all filter units and exits the air filter device through the air outlet 3. The filtered air is supplied to the equipment 8, which is sensitive to salt deposit, e.g. a turbine. At least the two filter units 6, 7 closest to the air outlet 3 comprise a filter medium capable of removing particulate material and/or airborne molecular contamination (AMC), and are thus able to remove any salt present in the an air flow passing through the air filter device. In the embodiments shown in FIG. 1, a salt load determining means 9 (i.e. a conductivity sensor) is located on the upstream surface 10 of the filter unit 6 which is arranged upstream the filter unit 7 closest to the air outlet 3. The filter units 4, 5 closer to the air intake 2 are optional, and may include filter media of a lower filter class than the filter units 6, 7 downstream thereof. The sensor 9 includes a display 13, to which it can be connected by means of a cable 14.

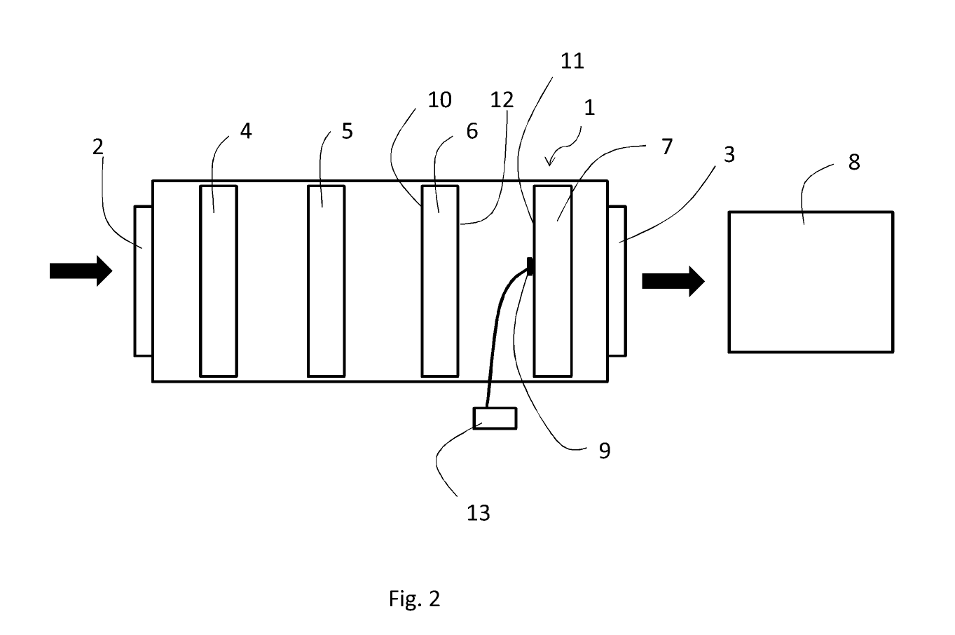

FIG. 2 shows an alternative embodiment, in which the conductivity sensor 9 is located on the upstream surface 11 of the filter unit 7, which is closest to the air outlet 3. In this embodiment, at least the filter unit 7 holding the sensor should include a filter medium capable of removing salt or salt containing particles from the air stream.

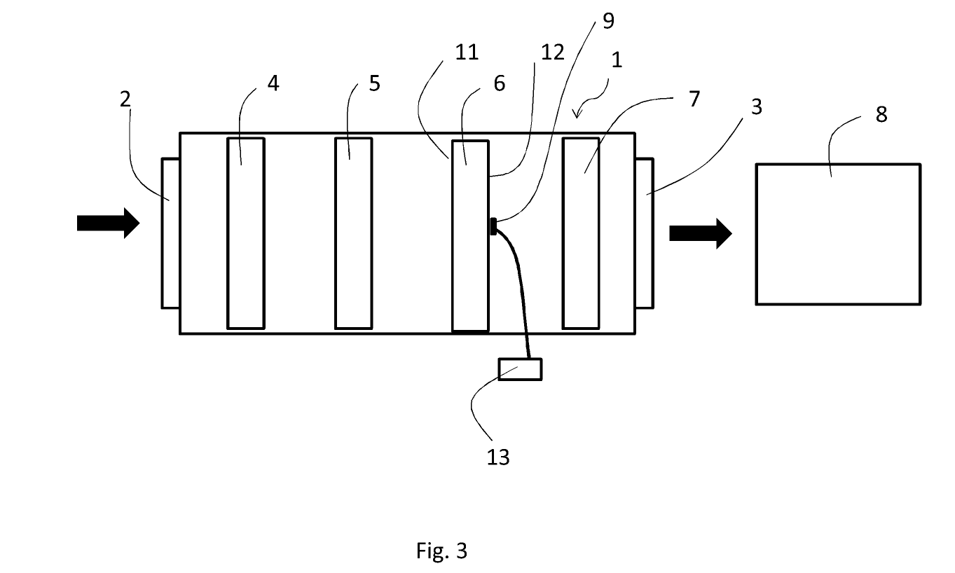

FIG. 3 shows another alternative embodiment, wherein the conductivity sensor 9 is located on the downstream surface 12 of the filter unit 6 which is arranged upstream the filter unit 7 closest to the air outlet 3.

The filter medium should be capable of entrapping salt particles, and is preferably chosen from a hydrophobic material, in order not to be affected by the humidity of the ambient air. Suitable materials for the filter medium are filter cloth of glass fibres or synthetic fibres, expanded Ptfe (ePtfe), or expanded ultra high density polyethylene (UPE). Different filter media can be chosen for the different filter units. Filter cloths are preferably pleated, and a plurality of filter panels may be mounted in a V-bank arrangement in one filter unit. Each filter unit used in the air filter device may be comprised of a plurality of sub-units, arranged in parallel in the air stream, such that the entire air stream reaches all sub-units of one filter unit at the same time. Thereby, the size of the filter unit can be adapted to the volume to be filtered.

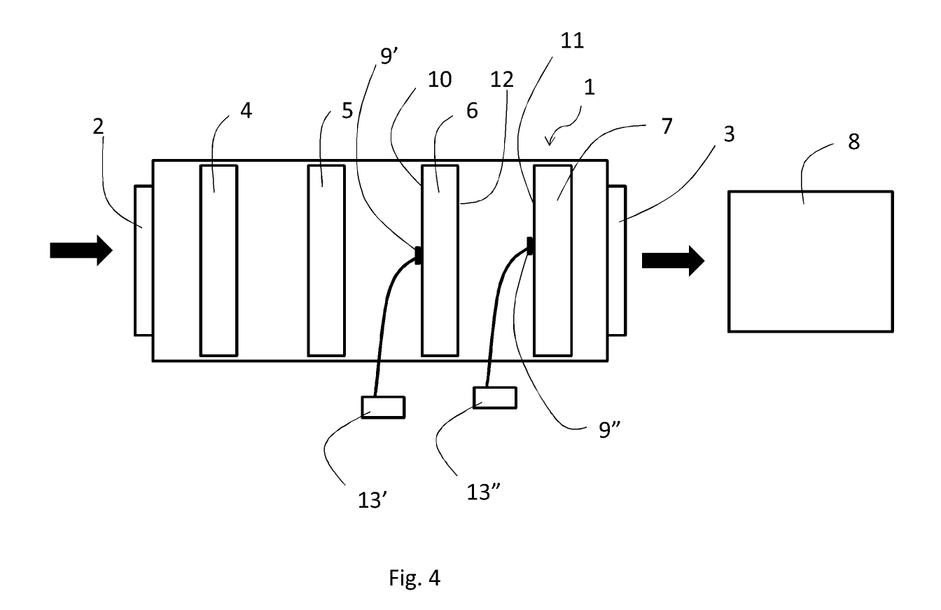

It may be desired to arrange sensors on the surface of two or more different filter units. Thereby, the condition of the filter units with regard to saturation can be monitored in at least two different filter steps, which allows a more detailed and balanced information of the saturation course in the filter device as a whole to be obtained. If desired two or more sensors may be arranged on the same filter unit, so that the degree of saturation can be monitored at different positions in one filter, whereby more detailed information of the remaining filter capacity can be obtained, and safety can be increased, as in case of malfunction of one sensor the other sensor may act as a back-up sensor. Also, in case of a possible uneven salt distribution in the filter medium, leading to uneven filtering capacity, it may be advantageous to arrange a plurality of sensors on a filter medium. FIG. 4 shows an embodiment, in which conductivity sensors 9′, 9″ are located on each of the upstream surfaces 10, 11 of the filter units 6, 7 which is arranged closest to the air outlet 3, and where the measured values are displayed in the display means 13′, 13″.

The conductivity determined or measured by the sensor can be obtained by any commercially available sensor which is capable of measuring conductivity or resistance between two points on a filter medium, such as a conductivity meter or an ohm meter. The sensor preferably includes two electrodes or contact elements positioned at a distance from each other on the surface of the filter medium, and in direct contact with the filter medium. The contact elements are connected to electric cables so that a voltage can be applied between the contact elements. The resistance of the filter medium can be obtained by an ohmmeter. The distance between the contact elements positioned on the filter medium is not critical as long as it is not too large. The distance between the contact elements should preferably be 5-100 mm, whereby a stable resistivity or conductivity value can be obtained, more preferably 10-80 mm. When a pleated filter medium is used, both contact elements are preferably applied to the same pleat in order to obtain a short enough distance between them. The contact elements can preferably be positioned in the central area of the filter unit or in an area below the central area of the filter unit. Thereby, a more reliable view of the filter condition can be obtained, since the central area or the area there below is most likely to reach maximum saturation first, due to the risk that salt or salt containing particles in the air stream may tend to sink in the vertical direction due to gravity.

A display unit associated with the sensor for displaying the conductivity value of the filter medium may be included in the air filter device or at a distance therefrom, to allow easy manual monitoring to be performed by an operator. This association between the sensor and the display can be obtained by means of a cable, blue tooth or other wireless communication.

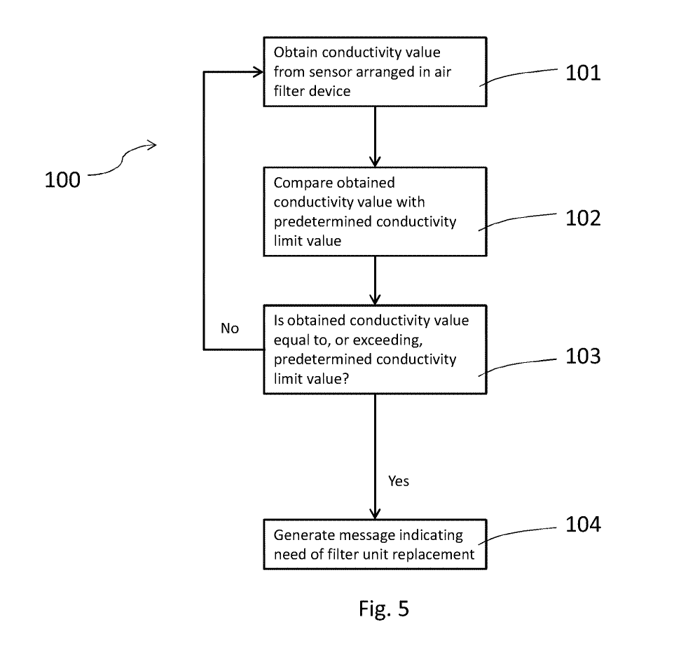

In a method of monitoring the filtration condition of a filter unit in the above described air filter device a conductivity value is obtained, and this value is compared with a predetermined conductivity limit value. If the measured conductivity value obtained from the sensor is equal to, or exceeds, the predetermined conductivity limit value, a message is generated, which indicates that preparations should be undertaken to replace the filter unit for a fresh one. The time frame for replacing the filter unit is determined on a case by case basis and will depend on various factors, such as the number of filter units present in the filter device, the position of the sensor in the filter device, and on the chosen conductivity limit value. The method of monitoring the filtration condition is illustrated in FIG. 5 wherein the steps of the method are:

obtaining a conductivity value of the filter medium from the air filter device 101; and

comparing the conductivity value from the air filter device with a predetermined conductivity limit value 102; and

analyzing the result of the comparison 103; and

if said conductivity value from the air filter device is equal to, or exceeds, said predetermined conductivity limit value, generating an message indicating that the preparations should be undertaken to replace the filter unit for a fresh one 104; or

if said conductivity value from the air filter device is not equal to, or exceeding, said predetermined conductivity limit value, obtaining a new conductivity value from the air filter device 101.

The predetermined conductivity limit value preferably represents a filtration condition where a predetermined degree of the filtration quantity capacity has not yet been reached. Thus this predetermined conductivity limit value should preferably correspond to a degree of salt saturation which is below the maximum degree of saturation, to avoid salt particles accidentally escaping from the downstream side of the filter unit. In the context of this invention, the maximum degree of saturation of the filter medium is defined as the amount of salt that can be contained by the filter medium without any salt particles being formed or escaping downstream of the filter medium when positioned in a filter unit at a certain relative air humidity. The maximum degree of saturation of the filter medium used in a filter unit and its corresponding conductivity value can be experimentally obtained for the configuration of each filter unit or filter material.

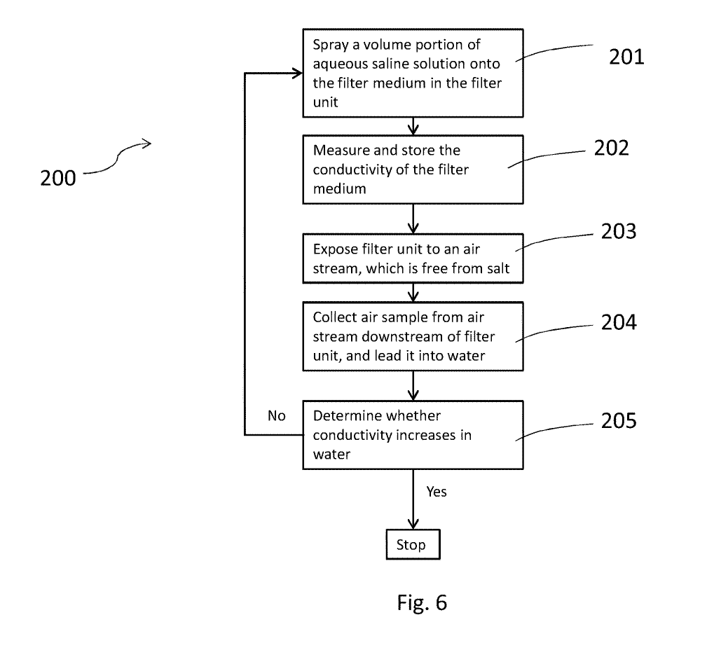

The maximum degree of saturation of the filter medium can for example be obtained by means of the following method 200 which is illustrated in FIG. 6. A filter unit comprising the filter medium to be tested is loaded with a gradually increased amount of salt 201, by spraying predetermined volume portions of an aqueous saline solution having a known salt content onto the filter medium. After each volume portion of saline solution has been supplied to the filter medium, the conductivity of the filter media is measured by means of e.g. an ohm meter having contact electrodes attached to the filter medium, and the measured value is stored 202. The filter unit is then exposed to an air stream 203, which is free from salt, and which should have a relative humidity (RH) corresponding to the air in the contemplated application of the filter device, e.g. RH 95%. A sampling probe is placed in the air stream downstream the filter unit to collect an air sample, which is led into a water volume held in a container 204, whereby presence of salt in the water will result in increased conductivity, which can be detected by e.g. a conductivity meter 205. If the filter material has reached the maximum salt load capacity, salt particles will escape from the filter downstream the filter unit. The conductivity of the filter medium obtained after the salt supply that caused salt particles to emerge downstream the filter unit corresponds to the maximum saturation degree of the filter unit. By storing all intermediate conductivity values together with their corresponding salt load, reference curves can be obtained, which can be used for monitoring the course of salt saturation in an air filter device during use. Other methods of evaluating the maximum salt load capacity known in the art may also be used, such as determining presence of salt downstream the filter unit by means of a laser particle counter or a sodium flame photometer.

A filter monitoring system for monitoring the condition of a filter unit comprises the above air filter device, and a control unit comprising a memory unit and a processor, wherein the memory unit is arranged to be able to store computer readable code that when executed on the processor performs the above method, thereby providing automatic monitoring of the filter condition and automatic generation of a message indicating the need of filter replacement. If desired reference values for different filter saturation degrees can be stored in the memory unit, to allow provision of current information on the filter condition during the saturation course. Preferably, the filter monitoring system includes means for communication with an external recipient, for example via the internet, so that the condition of the filter unit can be monitored at a remote location.

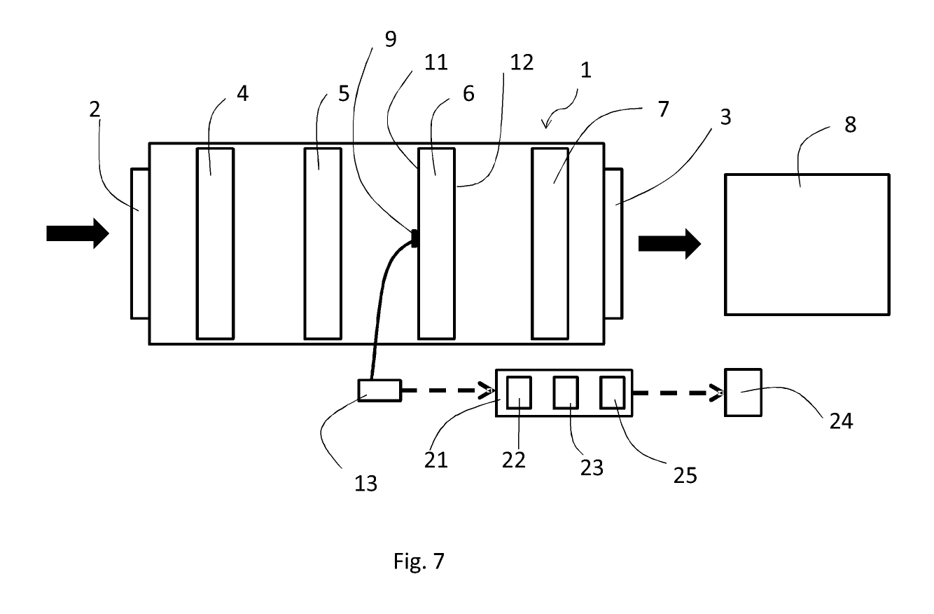

FIG. 7 illustrates a system 20 for monitoring the filtration condition, including an air filter device 1. In FIG. 7 an air filter device as illustrated in FIG. 1 is shown, but any position of the conductivity sensor could of course be contemplated. The system also includes a control unit 21 comprising a memory unit 22 and a processor 23, wherein the memory unit 22 is arranged to be able to store computer readable code that when executed on the processor 23 performs the method illustrated in FIG. 5. The signal generated in the system, indicating the need for replacement of the filter unit can be sent to the recipient 24 via the means for communication 25.

A computer program product is also provided, which is arranged to perform the above method of monitoring the filtration condition of a filter unit, when executed in a filter monitoring system as described above.

As an alternative to a sensor determining the conductivity of the filter medium, the salt content can be determined by means of spectroscopy. The monitoring is performed by means of a spectrometer arranged adjacent to the surface of the filter medium. Absorption spectroscopy measures the absorption of radiation, as a function of frequency or wavelength, due to its interaction with a sample (filter medium). Absorption spectroscopy can be used to determine the presence of salt in the filter medium and to quantify the amount thereof. Infrared or ultraviolet-visible spectroscopy can also be used. There is a wide range of experimental approaches to measuring absorption spectra. For example, a generated beam of radiation can be directed at the filter medium and the intensity of the radiation that passes through it can be detected. The transmitted energy can be used to calculate the absorption. The source and detection technique can vary depending on the frequency range. Raman Spectroscopy is based on that all substances vaporize molecules that can be detected with their own specific spectral signature while being exposed to an appropriate light. Raman Spectroscopy utilises the weak interaction between molecule vibrations and light. By exposing molecules to specific light they start to vibrate and emit a spectrum of light. The spectral read out is like a fingerprint, which is unique to the specific substance, i.e. salt in the present case, and it is called the Raman spectrum. Colour Measurements can also be performed with an RGB-detector.

### EXAMPLES

The following experiments illustrate how the conductivity that can be detected in a filter medium is correlated to the salt amount loaded on the filter medium. A glass fiber GT 190 GH filter medium available from H&V, having 44 pleats/dm and a pleat height of 26.5 mm and a total area of 29 m² was loaded with salt by spraying an aqueous saline solution by means of ejector nozzles onto the filter medium at about 20° C. The aqueous saline solution was obtained by dissolving 3.5% by weight of salt (coarse-grained salt (NaCl) with anticaking agent E535/536 available from Falk™) in tap water.

Contact elements in the form of crocodile clips (A-D) were attached to the filter medium, and each crocodile clip was connected to a cable. The distances between pairs of crocodile clips are shown in Table 1. A defined electricity of 415V was applied through the cables. The resistance of the filter medium was measured. Voltmeters were used to measure the volt and ampere values which were flowing in the filter medium.

TABLE 1

| Contact | Distance between contact |
|---|---|
| elements | elements (mm) |
| A/B | 14 |
| B/C | 78 |
| A/C | 92 |
| A/D | 300 |

### Example 1

### Salt Loading Test

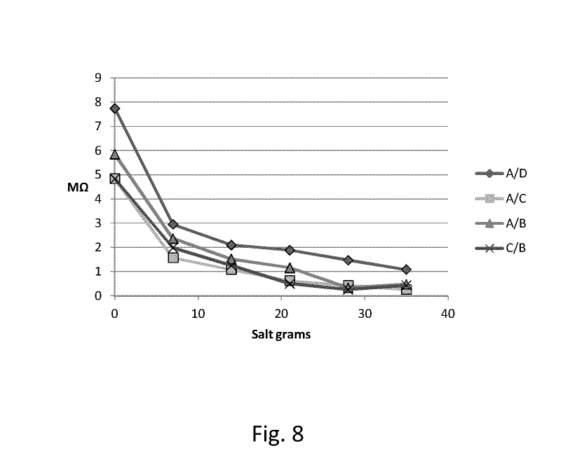

The filter medium as described above was loaded stepwise with salt in amounts as shown in Table 2, and the resistance was measured after each loading step. The result is also shown in FIG. 8. The relative humidity in this experiment was about 90% and the temperature was about 20° C.

TABLE 2

| Total | Salt | Distance and Resistance between contact elements (kΩ) | | | |
|---|---|---|---|---|---|
| salt | load | A/D | A/C | A/B | C/B |
| in g | (g/m²) | 300 mm | 92 mm | 14 mm | 78 mm |
| 0 | 0 | 77.9 | 48.7 | 58.9 | 48.7 |
| 7 | 0.24 | 29.7 | 15.8 | 23.8 | 20.0 |
| 14 | 0.48 | 21.2 | 10.9 | 15.3 | 12.7 |
| 21 | 0.72 | 19.0 | 6.3 | 11.7 | 5.1 |
| 28 | 0.97 | 14.8 | 4.4 | 3.4 | 2.7 |
| 35 | 1.21 | 10.9 | 2.7 | 4.9 | 4.4 |

The results shown in Table 2 indicate that the presence of salt can be detected already at a salt load of 0.24 g/m², and that the distance between the contact elements is not critical as long as the distance between the contact elements is not more than about 100 mm.

### Example 2

### Humidity Test

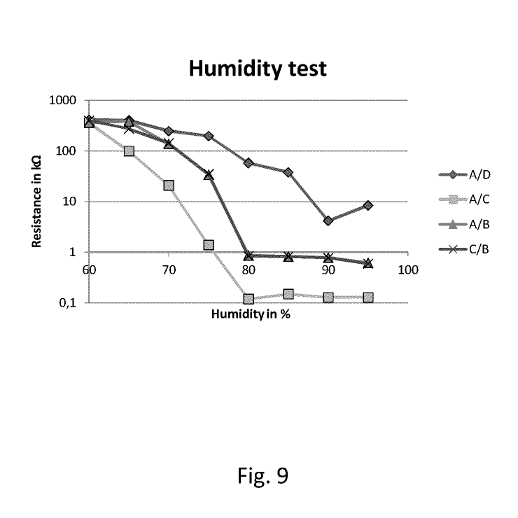

The filter medium as described above was loaded with 35 g salt, i.e. 1.21 g/m² of salt shown in Table 2. The filter medium was exposed to water vapour by means of a Dristeem™ vapor logic 4 steam generator at 20° C., so that a gradually increasing relative humidity in the air around the filter medium was obtained, and the resistance was measured as the humidity gradually increased. The result is shown in Table 3 and is also shown in FIG. 9.

TABLE 3

| | Distance and Resistance between contact elements (kΩ) | | | |
|---|---|---|---|---|
| RH in % | A/D | A/C | A/B | C/B |
| at 20° C. | 300 mm | 92 mm | 14 mm | 78 mm |
| 60 | 409 | 360 | 360 | 398 |
| 65 | 400 | 99 | 385 | 272 |
| 70 | 247 | 21 | 139 | 143 |
| 75 | 197 | 1.4 | 34 | 35 |
| 80 | 58 | 0.12 | 0.87 | 0.85 |
| 85 | 38 | 0.15 | 0.83 | 0.83 |
| 90 | 4.2 | 0.13 | 0.79 | 0.78 |
| 95 | 8.4 | 0.13 | 0.62 | 0.6 |

The results shown in Table 3 indicate that at a salt load of 35 g salt, (1.21 g/m²), a relative humidity of 60% is sufficient for detection of the salt effect on the conductivity, and that the resistance value is substantially constant at humidities of RH 80% and above. Also it can be noted that a distance of below 100 mm between the contact elements gives a stable result.

1. An air filter device comprising an air flow intake and an air outlet and at least one air filter unit including a filter medium capable of removing particulate material and/or airborne molecular contamination (AMC) from an air flow passing through the filter unit, said filter medium having an upstream surface directed towards the air flow intake, and a downstream surface directed towards the air flow outlet, and a salt load sensor for determining presence of salt entrapped by the filter medium is provided in connection to the filter medium, said filter device being arranged to be able to provide an output corresponding to the amount of salt entrapped by the filter medium by said salt load sensor.

2. (canceled)

3. The air filter device of claim 1, wherein the salt load sensor is a sensor for determining the conductivity of the filter medium is positioned on the filter medium, said filter device being arranged to be able to provide an output corresponding to a conductivity value from said sensor.

4. The air filter device of claim 1, wherein the salt load sensor is positioned on, or adjacent to, the upstream surface of the filter medium.

5. The air filter device of claim 1, comprising at least a first filter and a second filter, wherein the first filter includes the salt load sensor positioned on the filter medium, said first filter being arranged upstream of the second filter.

6. The air filter device of claim 5, wherein one or more additional filter are arranged upstream said first filter, and wherein one or more of the filter closest to the air intake preferably includes a filter medium with lower filter class than the filter downstream thereof.

7. The air filter device of claim 1, wherein at least one salt load sensor is positioned on the surface of the filter medium of each of at least two different filter.

8. The air filter device of claim 1, further comprising a display associated with the sensor for displaying the conductivity value of the filter medium.

9. A method of monitoring a filtration condition of a filter in an air filter device according to claim 1, comprising the steps of:
obtaining a salt load value from said air filter device, said salt load value corresponding to the amount of salt entrapped by the filter medium;
comparing said salt load value with a predetermined salt load limit value;
if said salt load value from said air filter device is equal to, or exceeds, said predetermined salt load limit value, generating a message indicating that the preparations should be undertaken to replace the filter for a fresh one.

10. The method of claim 9, wherein the salt load value is a conductivity value, and the predetermined salt load limit value as a conductivity limit value.

11. The method of claim 10, wherein the conductivity is obtained by measuring the electrical resistance in the filter medium.

12. The method of any one of claim 9, wherein the predetermined salt load limit value represents a filtration condition where a predetermined degree of the filtration quantity capacity has been reached.

13. A filter monitoring system, comprising an air filter device according to claim 1, and further comprising a control comprising a memory and a processor, wherein the memory is arranged to be able to store computer readable code that when executed on the processor performs a method comprising monitoring a filtration condition of a filter in an air filter device according to claim 1, comprising the steps of:
obtaining a salt load value from said air filter device, said salt load value corresponding to the amount of salt entrapped by the filter medium;
comparing said salt load value with a predetermined salt load limit value;
if said salt load value from said air filter device is equal to, or exceeds, said predetermined salt load limit value, generating a message indicating that the preparations should be undertaken to replace the filter for a fresh one.

14. The filter monitoring system of claim 13, further comprising means for communication with an external recipient.

15. A computer program product arranged to perform the method according to claim 9.

16. A method of manufacturing an air filter device comprising monitoring a filtration condition of a filter in the air filter device according to the method of claim 9, and replacing the filter for a fresh one after said message is generated.
